(19) United States
(12) Patent Application Publication
(10) Pub. No.: US 2026/0132321 A1
(43) Pub. Date: May 14, 2026

(54) NEGATIVE ELECTRODE BINDER, AND PREPARATION METHOD THEREOF AND APPLICATION THEREOF

(71) Applicants: Shenzhen Haofei New Material Co., Ltd., Guangdong (CN); Anhui Haofei New Material Co., Ltd., Anhui (CN); Shenzhen Haofei Industry Co., Ltd., Guangdong (CN)

(72) Inventors: Lingling HOU, Guangdong (CN); Zhen FAN, Guangdong (CN)

(73) Assignees: Shenzhen Haofei New Material Co., Ltd., Guangdong (CN); Anhui Haofei New Material Co., Ltd., Anhui (CN); Shenzhen Haofei Industry Co., Ltd., Guangdong (CN)

(21) Appl. No.: 19/430,125

(22) Filed: Dec. 22, 2025

Related U.S. Application Data
(63) Continuation of application No. PCT/CN2023/141902, filed on Dec. 26, 2023.

(30) Foreign Application Priority Data
Jul. 31, 2023 (CN) 202310947703.4

(51) Int. Cl. C09J 175/04; C09J 11/06; H01M 4/62

(52) U.S. Cl. CPC C09J 175/04; C09J 11/06; H01M 4/622

(57) ABSTRACT

The present application provides a negative electrode binder and a preparation method thereof and an application thereof. Raw materials for preparing the negative electrode binder include a soft monomer, a hard monomer, a urethane bond-containing acrylate monomer, an emulsifier, an initiator and water; and the urethane bond-containing acrylate monomer is prepared by a reaction of a small molecule diol monomethyl ether and a diisocyanate, and followed by end-capping with an acrylate containing a terminal hydroxyl group. The negative electrode binder has characteristics such as high bonding performance, good flexibility, resistance to electrolyte swelling and high temperature stability.

### CROSS-REFERENCE TO RELATED APPLICATION

The present application is a continuation of International Application No. PCT/CN2023/141902, filed Dec. 26, 2023, which claims priority to the Chinese Patent Application No. 202310947703.4, filed with China National Intellectual Property Administration on Jul. 31, 2023, entitled “Negative Electrode Binder, and Preparation Method thereof and Application thereof”. The aforementioned patent applications are hereby incorporated by reference in their entireties.

### TECHNICAL FIELD

The present application relates to the technical field of binder, and in particular, to a negative electrode binder, and a preparation method thereof and an application thereof.

### RELATED ART

As an essential additive in lithium-ion batteries, the binder serves two primary functions in the battery: (1) it binds scattered active materials into a regular whole, increasing contact between active material particles to improve electrical conductivity, thereby enhancing energy storage performance; (2) it adheres the active materials to current collectors, preventing open circuits caused by active material detachment and ensuring normal operation of the battery, and thus the binder is crucial to lithium-ion batteries.

As an additive, the binder accounts for only about 1% of an entire electrode material, with a low addition amount, but the performance requirements are high. Firstly, the binder needs to have good bonding ability. Secondly, during an operation of the battery, the binder needs to be immersed in an electrolyte environment, and thus it is necessary to ensure that the binder will not be dissolved or swollen by the electrolyte and thus fails. Finally, during a use of the battery, it needs to face temperature changes caused by the environment and its own internal resistance, and thus the binder needs to have good temperature stability.

Polyvinylidene fluoride (PVDF) is one of the primary binders used in both positive and negative electrodes of lithium batteries, and it can meet the basic requirements as an electrode binder and is thus widely used. CN112310399A discloses a silicon negative electrode binder of a lithium-ion battery and an electrode preparation method thereof and an application thereof. The silicon negative electrode binder of the lithium-ion battery is composed of polyvinylidene fluoride and polyvinyl alcohol in a mass ratio of 10-1:1-10. This silicon negative electrode binder of the lithium-ion battery may effectively inhibit irreversible lithium consumption of the electrode while enhancing an overall bonding force of the electrode. However, PVDF has a low elastic modulus and poor flexibility, and its processing needs to use toxic solvents, which is inconsistent with current concept of energy-saving and environmental protection. Consequently, PVDF is gradually being replaced by safe and environmentally friendly water-based binders.

CN113066982A discloses a modified water-based binder and a preparation method thereof and an application thereof. The modified water-based binder includes a main monomer, a soft monomer, and a homopolymer; where the main monomer includes a polyacrylate, the soft monomer includes a copolymerized 2-benzoyl-3-hydroxy-1-propene and/or an isooctyl acrylate, and the homopolymer includes a polymethyl methacrylate. The modified water-based binder exhibits high overall bonding strength, good dispersibility, and stable performance in electrolyte solutions.

Water-based binders such as polyacrylic acid (PAA), polyacrylates (e.g., lithium polyacrylate, sodium polyacrylate, or potassium polyacrylate), chitosan and derivatives thereof, lithium carboxymethylcellulose (CMCLi), sodium carboxymethyl cellulose (CMCNa), styrene-butadiene rubber (SBR), or polytetrafluoroethylene (PTFE), outperform PVDF in battery performance, offering some improvements in electrode cycling stability and electrochemical stability. However, certain shortcomings remain: for instance, CMCNa and PAA suffer from problems such as insufficient bonding strength and high brittleness, while chitosan exhibits poor cycling stability that fails to meet application requirements.

Therefore, it is necessary to develop a binder with high bonding performance, good flexibility, resistance to electrolyte swelling, and high temperature stability.

### SUMMARY OF INVENTION

### Technical Problem

In view of the shortcomings of the prior art, an objective of the present application is to provide a negative electrode binder and a preparation method thereof and an application thereof. The negative electrode binder has characteristics such as high bonding strength, good flexibility, resistance to electrolyte swelling and high temperature stability.

### Solution to Problem

To achieve this objective, the present application employs the following technical solutions.

In a first aspect, the present application provides a negative electrode binder, where raw materials for preparing the negative electrode binder include a soft monomer, a hard monomer, a urethane bond-containing acrylate monomer, an emulsifier, an initiator and water; and the urethane bond-containing acrylate monomer is prepared by reacting a small molecule diol monomethyl ether with a diisocyanate, and followed by end-capping with an acrylate containing a terminal hydroxyl group.

In the present application, the urethane bonds can provide excellent bonding performance and flexibility. For example, water-based polyurethane itself contains abundant urethane bonds, exhibiting good bonding performance and flexibility, and as a binder with superior performance, it is widely used in other industries such as furniture and clothing. However, if polyurethane is used as a positive or negative electrode binder, it is not conductive by itself, which will seriously affect the performance of the battery. If polyurethane is blended with polyacrylate to form a binder, polyurethane may impart the binder good bonding performance and flexibility, and polyacrylate may impart the binder appropriate conductivity, which seems to solve the problems existing in binders of the prior art. However, most commercially available polyurethanes are designed for other applications and typically feature high molecular weights (number-average molecular weight>1000 g/mol). These high-molecular-weight polyurethanes contain long chains of polyether or polyester, which are readily dissolved under the influence of electrolytes, leading to binder degradation and failure.

By compounding formulation of soft monomers, hard monomers, and urethane bond-containing acrylate monomer, the present application introduces urethane bonds into the negative electrode binder through free radical emulsion polymerization, which significantly enhances the bonding performance of the binder, and the prepared negative electrode binder has characteristics such as high bonding performance, good flexibility, resistance to electrolyte swelling and high temperature stability.

In the present application, the hard monomers in the raw materials for preparing the negative electrode binder have a relatively high glass transition temperature, which not only enhances structural strength of the binder but also increases a thermal decomposition temperature of the negative electrode binder. The soft monomers have a lower glass transition temperature, which imparts the negative electrode binder with excellent bonding performance and flexibility. The urethane bond-containing acrylate monomer is an important component in the negative electrode binder, and is prepared from a small molecule diol monomethyl ether, diisocyanate and an acrylate containing a terminal hydroxyl group. The small molecule diol monomethyl ether contains ethoxy groups, which can improve the electrochemical performance of the binder, the acrylate containing a terminal hydroxyl group mainly serves to provide the acrylic group that can participate in free radical polymerization, and the diisocyanate acts as a bridging agent between the former two, generating a urethane bond through the reaction to enhance the bonding performance.

In one implementation, the soft monomer includes any one or a combination of at least two of alkyl acrylate, ethoxy acrylate, methoxy polyethylene glycol methacrylate, methoxy diethylene glycol methacrylate, alkyl methacrylate, or methoxyethyl acrylate, and is further alkyl acrylate and/or ethoxy acrylate.

In one implementation, the hard monomer includes any one or a combination of at least two of styrene, isobornyl acrylate, isobornyl methacrylate, methyl methacrylate, or diisopropylbenzene.

In one implementation, the small molecule diol monomethyl ether includes any one or a combination of at least two of ethylene glycol monomethyl ether, propylene glycol monomethyl ether, diethylene glycol monomethyl ether, or dipropylene glycol monomethyl ether.

In one implementation, the diisocyanate includes any one or a combination of at least two of isophorone diisocyanate, dicyclohexylmethane diisocyanate, toluene diisocyanate, or diphenylmethane diisocyanate, and is further isophorone diisocyanate.

In the present application, the urethane bond-containing acrylate monomer is prepared by reacting the small molecule diol monomethyl ether with isophorone diisocyanate, and end-capping by using the acrylate containing a terminal hydroxyl group, and a ring structure is introduced, which enhances the flexibility and further improves the performance of the negative electrode binder.

In one implementation, the acrylate containing a terminal hydroxyl group includes any one or a combination of at least two of hydroxyethyl methacrylate, hydroxyethyl acrylate, hydroxypropyl methacrylate, or hydroxypropyl acrylate.

In one implementation, a molar ratio of the small molecule diol monomethyl ether, diisocyanate, and the acrylate containing a terminal hydroxyl group is 1:1:1.

In one implementation, the reaction involves adding the diisocyanate dropwise to the small molecule diol monomethyl ether.

In one implementation, a reaction temperature is 10° C. or below, for example, 0° C., 1° C., 2° C., 3° C., 4° C., 5° C., 6° C., 7° C., 8° C. or 9° C., etc.

In one implementation, a reaction time is 1-2 hours, for example, 1.1 hours, 1.2 hours, 1.3 hours, 1.4 hours, 1.5 hours, 1.6 hours, 1.7 hours, 1.8 hours or 1.9 hours, etc.

In one implementation, an end-capping temperature is 70-80° C., for example, 71° C., 72° C., 73° C., 74° C., 75° C., 76° C., 77° C., 78° C. or 79° C., etc.

In one implementation, the end-capping time is 2-3 hours, for example, 2.1 hours, 2.2 hours, 2.3 hours, 2.4 hours, 2.5 hours, 2.6 hours, 2.7 hours, 2.8 hours or 2.9 hours, etc.

In one implementation, the emulsifier includes an anionic emulsifier and a nonionic emulsifier.

In one implementation, a mass ratio of the anionic emulsifier to the nonionic emulsifier is 1:1-2, for example, 1:1.1, 1:1.2, 1:1.3, 1:1.4, 1:1.5, 1:1.6, 1:1.7, 1:1.8 or 1:1.9, etc.

In one implementation, the anionic emulsifier includes any one or a combination of at least two of sodium dodecyl sulfonate (LAS), sodium dodecyl sulfate (SDS), or sodium dodecyl benzene sulfonate (SDBS).

In one implementation, the nonionic emulsifier includes any one or a combination of at least two of octylphenol polyoxyethylene ether (OP-10), sorbitan oleate, or fatty alcohol polyoxyethylene ether.

In one implementation, the sorbitan oleate includes Span-20 and/or Span-80.

In one implementation, the fatty alcohol polyoxyethylene ether includes AEO-9 and/or AEO-10.

In one implementation, the initiator includes any one or a combination of at least two of ammonium persulfate (APS), potassium persulfate (KPS), azobisisobutyronitrile (AIBN), or dibenzoyl peroxide (BPO).

In one implementation, the raw materials for preparing the negative electrode binder include the following components by mass: 20-35 parts (for example 21 parts, 23 parts, 25 parts, 27 parts, 29 parts, 30 parts, 32 parts or 34 parts, etc.) of soft monomer, 15-30 parts (for example 16 parts, 18 parts, 20 parts, 22 parts, 24 parts, 26 parts, 28 parts or 29 parts, etc.) of hard monomer, 2-5 parts (for example 2.3 parts, 2.5 parts, 2.8 parts, 3 parts, 3.5 parts, 4 parts, 4.2 parts, 4.5 parts or 4.8 parts, etc.) of urethane bond-containing acrylate monomer, 1.5-3.5 parts (for example 1.7 parts, 1.9 parts, 2.0 parts, 2.3 parts, 2.5 parts, 2.8 parts, 3 parts, 3.2 parts or 3.4 parts, etc.) of emulsifier, 0.03-0.1 parts (for example 0.04 parts, 0.05 parts, 0.06 parts, 0.07 parts, 0.08 parts or 0.09 parts, etc.) of initiator, and 35-65 parts (for example 37 parts, 40 parts, 42 parts, 45 parts, 48 parts, 50 parts, 52 parts, 55 parts, 58 parts, 60 parts or 63 parts, etc.) of water.

In the present application, if parts by mass of the soft monomers are too low, the bonding performance and flexibility of the negative electrode binder decrease, if the parts by mass of the soft monomers are too high, the glass transition temperature of the resulting negative electrode binder becomes too low, preventing proper curing, making it difficult to maintain mechanical strength, and reducing resistance to electrolyte swelling. If parts by mass of the urethane bond-containing acrylate monomer are too low, the urethane bond-containing acrylate monomer cannot fulfill their intended function, resulting in poor bonding performance of the prepared negative electrode binder, and if the parts by mass of the urethane bond-containing acrylate monomer are too high, there are excessive amino groups in the resulting negative electrode binder system, causing the emulsion prone to react and deteriorate, and reducing resistance to electrolyte swelling.

In a second aspect, the present application provides a preparation method for the negative electrode binder as described in the first aspect, where the preparation method includes the following steps: mixing the soft monomer, hard monomer, urethane bond-containing acrylate monomer, emulsifier, water and initiator, and reacting to obtain the negative electrode binder.

In one implementation, the mixing includes the following steps:
(1) mixing part of the emulsifier with part of water to obtain a base solution; mixing the soft monomer, the hard monomer, the urethane bond-containing acrylate monomer, the remaining emulsifier, and part of water to obtain an emulsion;
(2) mixing the base solution from step (1), the emulsion from step (1), and the initiator.

In one implementation, based on 100% of a total mass of the emulsifier, the part of emulsifier in the preparation of the base solution of step (1) has a mass percentage of 30-35%, for example, 30.5%, 31%, 32%, 32.5%, 33%, 33.5%, 34% or 34.5%, etc.

In one implementation, based on 100% of a total mass of water, the part of water in the preparation of the base solution of step (1) has a mass percentage of 65-70%, for example, 65.5%, 66%, 66.5%, 67%, 67.5%, 68%, 68.5%, 69% or 69.5%, etc.

In one implementation, based on 100% of a total mass of emulsifier, the remaining emulsifier in the preparation of the base solution of step (1) has a mass percentage of 65-70%, for example 65.5%, 66%, 66.5%, 67%, 67.5%, 68%, 68.5%, 69% or 69.5%, etc.

In one implementation, based on 100% of a total mass of water, the part of water in the preparation of the base solution of step (1) has a mass percentage of 30-35%, for example, 30.5%, 31%, 31.5%, 32%, 32.5%, 33%, 33.5%, 34% or 34.5%, etc.

In one implementation, the mixing in step (2) includes adding the emulsion and the initiator dropwise to the stirred base solution.

In one implementation, the reaction temperature is 83-85° C., for example, 83.2° C., 83.5° C., 84° C., 84.5° C., or 84.8° C., etc.

In one implementation, the reaction time is 1-2 hours, for example, 1.1 hours, 1.2 hours, 1.3 hours, 1.4 hours, 1.5 hours, 1.6 hours, 1.7 hours, 1.8 hours, or 1.9 hours, etc.

In a third aspect, the present application provides a negative electrode slurry of a battery, including the negative electrode binder as described in the first aspect.

In a fourth aspect, the present application provides a negative electrode sheet, including the negative electrode binder as described in the first aspect or the negative electrode slurry of the battery as described in the third aspect.

In a fifth aspect, the present application provides an electrochemical energy storage device, including the negative electrode binder as described in the first aspect or the negative electrode slurry of the battery as described in the third aspect.

In one implementation, the electrochemical energy storage device includes a lithium-ion battery.

### Effects of Invention

Compared to the prior art, the present application offers the following beneficial effects.

By compounding formulation of components such as soft monomers, hard monomers, and urethane bond-containing acrylate monomers, the present application introduces urethane bonds into the negative electrode binder through free radical emulsion polymerization, which significantly enhances the bonding performance of the binder. The prepared negative electrode binder has characteristics such as high bonding performance, good flexibility, resistance to electrolyte swelling and high temperature stability. The preparation method of the negative electrode binder is simple, and the product is safe and environmentally friendly. A bonding strength of the binder is 3.52-7.88 N/m and a swelling rate is 45-150%, in further, the bonding strength of the negative electrode binder is 5.45-7.88 N/m and the swelling rate is 48-64%.

### DESCRIPTION OF EMBODIMENTS

Technical solutions of the present application are further illustrated through specific embodiments. Those skilled in the art should understand that the embodiments are merely provided to aid in understanding the present application and should not be regarded as specific limitations on the present application.

All “parts” mentioned below refer to “parts by mass”.

### Preparation Example 1

A urethane bond-containing acrylate monomer, specifically a urethane bond-containing acrylate monomer A, is prepared as follows:
a reaction apparatus which is cooled by an ice-water bath is set up; dehydrated ethylene glycol monomethyl ether is placed at a bottom of a reaction vessel and stirred at a speed of 100 rpm, and then isophorone diisocyanate is dropwise added into the reaction vessel via a constant-pressure dropping funnel (maintaining the reaction temperature at 9° C. during the dropwise addition) at a dropping rate of approximately 1 mL/min; after the dropwise addition is completed, the reaction is continued for 1 hour, and then the temperature is raised to 70° C., and hydroxyethyl methacrylate is added to the reaction vessel, after 3 hours of continuous stirring, the reaction is terminated by cooling.

A molar ratio of ethylene glycol monomethyl ether, isophorone diisocyanate, and hydroxyethyl methacrylate described above is 1:1:1.

### Preparation Example 2

A urethane bond-containing acrylate monomer, specifically a urethane bond-containing acrylate monomer B, is prepared as follows:
a reaction apparatus which is cooled by an ice-water bath is set up; dehydrated propylene glycol monomethyl ether is placed at a bottom of a reaction vessel and stirred at a speed of 100 rpm, and then isophorone diisocyanate is added dropwise into the reaction vessel via a constant-pressure dropping funnel (maintaining the reaction temperature at 5° C. during the dropwise addition) at a dropping rate of approximately 1 mL/min; after the dropwise addition is completed, the reaction is continued for 1.5 hours, and then the temperature is raised to 80° C., and hydroxypropyl methacrylate is added to the reaction vessel; after 2 hours of stirring, the reaction is terminated by cooling.

A molar ratio of propylene glycol monomethyl ether, isophorone diisocyanate, and hydroxypropyl methacrylate described above is 1:1:1.

### Preparation Example 3

A urethane bond-containing acrylate monomer, specifically a urethane bond-containing acrylate monomer C, is prepared as follows:
a reaction apparatus which is cooled by an ice-water bath is set up; dehydrated ethylene glycol monomethyl ether is placed at a bottom of a reaction vessel and stirred at a speed of 100 rpm, and then isophorone diisocyanate is dropwise added into the reaction vessel via a constant-pressure dropping funnel (maintaining the reaction temperature at 1° C. during the dropwise addition) at a dropping rate of approximately 1 mL/min; after the dropwise addition is completed, the reaction is continued for 2 hours, and then the temperature is raised to 75° C., and hydroxyethyl acrylate is added to the reaction vessel; after 2.5 hours of continuous stirring, the reaction is terminated by cooling.

A molar ratio of ethylene glycol monomethyl ether, isophorone diisocyanate, and hydroxyethyl acrylate described above is 1:1:1.

### Preparation Example 4

A urethane bond-containing acrylate monomer, specifically a urethane bond-containing acrylate monomer D, is prepared by a method that differs from preparation example 1 only in that isophorone diisocyanate is replaced with the same molar amount of hexamethylene diisocyanate, and all other conditions remain the same as in Preparation Example 1.

### Example 1

The present example provides a negative electrode binder and a preparation method thereof. Raw materials for preparing the negative electrode binder include 20 parts of soft monomers, 30 parts of hard monomer (styrene), 5 parts of urethane bond-containing acrylate monomer A prepared according to Preparation Example 1, 3.45 parts of emulsifiers, 0.09 parts of initiator (KPS), and 42 parts of water;
the soft monomers described above include 5 parts of butyl acrylate and 15 parts of isooctyl acrylate;
the emulsifiers described above include 1.15 parts of anionic emulsifier (SDS) and 2.3 parts of nonionic emulsifier (OP-10).

The preparation method of the above negative electrode binder is as follows:
14 parts of water, 1.5 parts of OP-10, and 0.75 parts of SDS are placed in a container, and is subjected to an emulsification treatment using a disperser at a speed of 700 rpm for 15 minutes, then 30 parts of styrene, 5 parts of butyl acrylate, 15 parts of isooctyl acrylate, and 5 parts of urethane bond-containing acrylate monomer A prepared according to Preparation Example 1 are sequentially added, and then further stirred and emulsified for 30 minutes to obtain a stable emulsion;
28 parts of water, 0.8 parts of OP-10, and 0.4 parts of SDS are placed in a reaction vessel and stirred at 200 rpm and heated to raise the temperature to 60° C., ⅕ of the emulsion is rapidly added to the reaction vessel, and then the temperature is further raised to 70° C. 0.03 parts of KPS dispersed in an appropriate amount of water are added to the reaction vessel and then the temperature is further raised to 83° C. and maintained for 1 hour; then the remaining emulsion and 0.06 parts KPS (dispersed in an appropriate amount of water) are added to the reaction vessel using a peristaltic pump over 3.5 hours. After that, the reaction is maintained at a constant temperature for 1.5 hours and then the temperature is cooled down to 50° C. to complete the reaction and discharge the product, thereby obtaining the negative electrode binder.

### Example 2

The present example provides a negative electrode binder and a preparation method thereof. Raw materials for preparing the negative electrode binder include 35 parts of soft monomers, 15 parts of hard monomer (isobornyl methacrylate), 2 parts of urethane bond-containing acrylate monomer B prepared according to Preparation Example 2, 1.5 parts of emulsifiers, 0.03 parts of initiator (APS), and 54 parts of water;
the soft monomers described above include 30 parts of butyl acrylate and 5 parts of methoxy polyethylene glycol 400 methacrylate;
the emulsifiers described above include 0.5 parts of anionic emulsifier (LAS) and 1 part of nonionic emulsifier (Span-20).

The preparation method of the above negative electrode binder is as follows:
18 parts of water, 0.65 parts of Span-20, and 0.35 parts of LAS are placed in a container, and is subjected to an emulsification treatment using a disperser at a speed of 700 rpm for 15 minutes, then 15 parts of isobornyl methacrylate, 30 parts of butyl acrylate, 5 parts of methoxy polyethylene glycol 400 methacrylate, and 2 parts of urethane bond-containing acrylate monomer B prepared according to Preparation Example 2 are sequentially added, and then further stirred and emulsified for 30 minutes to obtain a stable emulsion;
36 parts of water, 0.35 parts of Span-20, and 0.15 parts of LAS are placed in a reaction vessel and stirred at 200 rpm and heated to raise the temperature to 60° C., and ⅕ of the emulsion is rapidly added to the reaction vessel, and then the temperature to is raised to 70° C. 0.01 parts of APS dispersed in an appropriate amount of water is added to the reaction vessel and then the temperature is further raised to 85° C. and maintained for 1 hour; then the remaining emulsion and 0.02 parts APS (dispersed in an appropriate amount of water) are added to the reaction vessel using a peristaltic pump over 3.5 hours. After that, the reaction is maintained at the constant temperature for 2 hours and then the temperature is cooled down to 50° C. to complete the reaction and discharge the product, thereby obtaining the negative electrode binder.

### Example 3

The present example provides a negative electrode binder and a preparation method thereof. Raw materials for preparing the negative electrode binder include 25 parts of soft monomers, 25 parts of hard monomers, 4 parts of urethane bond-containing acrylate monomer C prepared according to Preparation Example 3, 1.93 parts of emulsifiers, 0.06 parts of initiator (BPO), and 39 parts of water;
the soft monomers described above include 20 parts of isooctyl acrylate and 5 parts of methoxy diethylene glycol methacrylate;
the hard monomers described above include 23 parts of styrene and 2 parts of diisopropylbenzene;
the emulsifiers described above include 0.88 parts of anionic emulsifier (SDBS) and 1.05 parts of nonionic emulsifier (OP-10).

The preparation method of the above negative electrode binder is as follows:
13 parts of water, 0.7 parts of OP-10, and 0.7 parts of SDBS are placed in a container, and is subjected to an emulsification treatment using a disperser at a speed of 700 rpm for 15 minutes, then 23 parts of styrene, 2 parts of diisopropylbenzene, 20 parts of isooctyl acrylate, 5 parts of methoxy diethylene glycol methacrylate, and 4 parts of urethane bond-containing acrylate monomer C prepared according to Preparation Example 3 are sequentially added, and then further stirred and emulsified for 30 minutes to obtain a stable emulsion;
26 parts of water, 0.35 parts of OP-10, and 0.18 parts of SDBS are placed in a reaction vessel and stirred at 200 rpm and heated to raise the temperature to 60° C., ⅕ of the emulsion is rapidly added to the reaction vessel, and then the temperature is further raised to 70° C. 0.02 parts of BPO dispersed in an appropriate amount of water are added to the reaction vessel and then the temperature is further raised to 84° C. and maintained for 1 hour, then the remaining emulsion and 0.04 parts BPO (dispersed in an appropriate amount of water) are added to the reaction vessel using a peristaltic pump over 3.5 hours. After that, the reaction is maintained at a constant temperature for 1 hour and then the temperature is cooled down to 50° C. to complete the reaction and discharge the product, thereby obtaining the negative electrode binder.

### Example 4

The present example provides a negative electrode binder and a preparation method thereof. Raw materials for preparing the negative electrode binder include 25 parts of soft monomers, 15 parts of hard monomer (styrene), 3 parts of urethane bond-containing acrylate monomer A prepared according to Preparation Example 1, 2.4 parts of emulsifiers, 0.03 parts of initiator (BPO), and 60 parts of water;
the soft monomers described above include 10 parts of butyl acrylate and 10 parts of isooctyl acrylate;
the emulsifiers described above include 0.9 parts of anionic emulsifier (SDBS) and 1.5 parts of nonionic emulsifier (AEO-10).

The preparation method of the above negative electrode binder is as follows:
20 parts of water, 1 part of AEO-10, and 0.6 parts of SDBS are placed in a container, and is subjected to an emulsification treatment using a disperser at a speed of 700 rpm for 15 minutes, then 15 parts of styrene, 10 parts of butyl acrylate, 10 parts of isooctyl acrylate, and 3 parts of urethane bond-containing acrylate monomer A prepared according to Preparation Example 1 are sequentially added, and then further stirred and emulsified for 30 minutes to obtain a stable emulsion;
40 parts of water, 0.5 parts of AEO-10, and 0.3 parts of SDBS are placed in a reaction vessel and stirred at 200 rpm and heated to raise the temperature to 60° C., ⅕ of the emulsion is rapidly added to the reaction vessel, then the temperature is further raised to 70° C. 0.01 parts of AIBN dispersed in an appropriate amount of butyl acrylate are added to the reaction vessel and then the temperature is further raised to 83° C. and maintained for 1 hour; then the remaining emulsion and 0.02 parts AIBN (dispersed in an appropriate amount of butyl acrylate) are added to the reaction vessel using a peristaltic pump over 3.5 hours. After that, the reaction is maintained at a constant temperature for 1.5 hours and then the temperature is cooled down to 50° C. to complete the reaction and discharge the product, thereby obtaining the negative electrode binder.

### Example 5

The present example provides a negative electrode binder and a preparation method thereof. Raw materials for preparing the negative electrode binder include 25 parts of soft monomer (isooctyl acrylate), 25 parts of hard monomers, 3 parts of urethane bond-containing acrylate monomer A prepared according to Preparation Example 1, 1.8 parts of emulsifiers, 0.09 parts of initiator (KPS), and 57 parts of water;
the hard monomers described above include 15 parts of styrene and 10 parts of isobornyl methacrylate;
the emulsifiers described above include 0.6 parts of anionic emulsifier (SDBS) and 1.2 parts of nonionic emulsifier (OP-10).

The preparation method of the above negative electrode binder is as follows:
19 parts of water, 0.8 parts of OP-10, and 0.4 parts of SDBS are placed in a container, and is subjected to an emulsification treatment using a disperser at a speed of 700 rpm for 15 minutes, then 15 parts of styrene, 10 parts of isobornyl methacrylate, 20 parts of isooctyl acrylate, and 3 parts of urethane bond-containing acrylate monomer A prepared according to Preparation Example 1 are sequentially added, and then is further stirred and emulsified for 30 minutes to obtain a stable emulsion;
38 parts of water, 0.4 parts of OP-10, and 0.2 parts of SDBS are placed in a reaction vessel and stirred at 200 rpm and heated to raise the temperature to 60° C., ⅕ of the emulsion is rapidly added to the reaction vessel, and then the temperature is further raised to 70° C. 0.03 parts of KPS dispersed in an appropriate amount of water are added to the reaction vessel and then the temperature is further raised to 83° C. and maintained for 1 hour; then the remaining emulsion and 0.06 parts KPS (dispersed in an appropriate amount of water) are added to the reaction vessel using a peristaltic pump over 3.5 hours. After that, the reaction is maintained at a constant temperature for 1.5 hours and then the temperature is cooled down to 50° C. to complete the reaction and discharge the product, thereby obtaining the negative electrode binder.

### Example 6

The present example provides a negative electrode binder and a preparation method thereof, differing from Example 1 only in that the parts by mass of the urethane bond-containing acrylate monomer A are adjusted to 6 parts, with other conditions same as Example 1.

### Example 7

The present example provides a negative electrode binder and a preparation method thereof, differing from Example 1 only in that the parts by mass of urethane bond-containing acrylate monomer A are adjusted to 1 part, with other conditions same as Example 1.

### Example 8

The present example provides a negative electrode binder and a preparation method thereof, differing from Example 1 only in that the parts by mass of urethane bond-containing acrylate monomer A are adjusted to 20 parts, and the soft monomer includes 10 parts of butyl acrylate and 30 parts of isooctyl acrylate, with other conditions same as Example 1.

### Example 9

The present example provides a negative electrode binder and a preparation method thereof, differing from Example 1 only in that the parts by mass of urethane bond-containing acrylate monomer A are adjusted to 16 parts, and the soft monomer includes 4 parts of butyl acrylate and 12 parts of isooctyl acrylate, with other conditions same as Example 1.

### Example 10

The present example provides a negative electrode binder and a preparation method thereof, differing from Example 1 only in that the urethane bond-containing acrylate monomer A are replaced by equivalent weight of the urethane bond-containing acrylate monomer D prepared according to Preparation Example 4, with other conditions same as Example 1.

### Comparative Example 1

The present comparative example provides a negative electrode binder and a preparation method thereof, differing from Example 1 only in that the urethane bond-containing acrylate monomer A is not added, with other conditions same as Example 1.

### Performance Tests

The following performance tests were conducted on the negative electrode binders provided in the examples and comparative examples.
(1) Bonding strength: a copper foil of the electrode sheet is cut into strips with specified length and width, then one side of the copper foil of the electrode sheet coated with a slurry (the slurry is a mixture of graphite, sodium carboxymethyl cellulose, and the above negative electrode binder with a mass ratio of 98:1:1, and a thickness of a dried coated slurry is 85 μm) is pasted onto a 3M adhesive tape, and the 3M adhesive tape is adhered on a stainless steel plate. After the sample is prepared, the stainless steel plate is fixed by a universal tensile machine, and the copper foil of the electrode sheet is peeled from the stainless steel plate at a 180° angle. To ensure the accuracy of the results, each sample is tested five times, and the highest and lowest values are removed, and the remaining values are averaged to obtain the bonding strength.
(2) Electrolyte swelling resistance: an appropriate amount of the above negative electrode binder is placed into a mold and is baked at 65° C. for 72 hours to dry, then a central portion is selected to cut a sample with a size of 1.5×1.5 cm² and a thickness of 3 mm, and a mass of the sample is weighed accurately and is denoted as m₁, then the sample is immersed in the electrolyte and placed in an environment of 65° C. for 72 hours. Subsequently the sample is taken out and residual liquid on the surface is absorbed by a dust-free paper, the mass of the sample is weighed again and is denoted as m₂, then the swelling rate is calculated using the following formula.

$$Swelling rate ( \% ) = \frac{{m}_{2} - {m}_{1}}{{m}_{1}} \times 100$$

(3) Flexibility test: an appropriate amount of the above negative electrode binder is placed into a mold and is baked at 65° C. for 72 hours to dry, then a central portion is selected to cut a sample with a size of 1.5×1.5 cm² and a thickness of 3 mm, and then the sample is manually folded 360° repeatedly 50 times.

After the test, there are no creases on the sample at all and it can automatically return to its original shape, indicating good flexibility and marked as “∘”.

After the test, there are slight creases on the sample and it could slowly return to its original shape, indicating average flexibility, marked as “Δ”.

After the test, there are severe cracks on the sample and it cannot return to its original shape, indicating very poor flexibility, marked as “x”.

Test results are shown in Table 1.

TABLE 1

| | Bonding | Swelling | |
|---|---|---|---|
| | strength (N/m) | rate (%) | Flexibility |
| Example 1 | 7.88 | 51 | Δ |
| Example 2 | 5.45 | 48 | ∘ |
| Example 3 | 5.71 | 52 | ∘ |
| Example 4 | 6.84 | 64 | Δ |
| Example 5 | 6.87 | 55 | Δ |
| Example 6 | 7.52 | 100 | ∘ |
| Example 7 | 5.85 | 61 | x |
| Example 8 | 7.43 | 150 | ∘ |
| Example 9 | 3.52 | 45 | x |
| Example 10 | 5.85 | 80 | ∘ |
| Comparative Example 1 | 4.62 | 75 | x |

According to the test results in Table 1, the bonding strength of the negative electrode binders provided in Examples 1-10 is 3.52-7.88 N/m, the swelling rate is 45-150% and the flexibility is average or good. The bonding strength of the negative electrode binders provided in Examples 1-5 is 5.45-7.88 N/m, the swelling rate is 48-64%, and the flexibility is average or good.

Compared to Example 1, if the parts by mass of the urethane bond-containing acrylate monomer are too high (Example 6), the swelling rate increases while the electrolyte swelling resistance decreases; if parts by mass of the urethane bond-containing acrylate monomer are too low (Example 7), the bonding strength decreases and the flexibility is poor, demonstrating that negative electrode binders prepared with a specific parts by mass of the urethane bond-containing acrylate monomer exhibit superior performance.

Compared to Example 1, if the parts by mass of the soft monomers are too high (Example 8), the swelling rate increases while the electrolyte swelling resistance decreases; if the parts by mass of the soft monomers are too low (Example 9), the bonding strength decreases and the flexibility is poor, demonstrating that negative electrode binders prepared with specific parts by mass of the soft monomers exhibit superior performance.

Compared to Example 1, if the urethane bond-containing acrylate monomer A is replaced with an equivalent mass of urethane bond-containing acrylate monomer D (Example 10), the bonding strength decreases, the swelling rate increases, and the electrolyte swelling resistance decreases, demonstrating that the negative electrode binders prepared by using a urethane bond-containing acrylate monomer derived from isophorone diisocyanate exhibit superior performance.

Compared to Example 1, if the urethane bond-containing acrylate monomer is not added (Comparative Example 1), the bonding strength decreases, the swelling rate increases, the flexibility is poor and the performance of the prepared negative electrode binder is poor.

The applicant declares that the present application illustrates a negative electrode binder and a preparation method thereof and an application thereof through the above examples. However, the present application is not limited to the above examples, that is, it does not mean that the present application must rely on them for implementation. Those skilled in the art should understand that any improvements to the present application, equivalent substitutions of raw materials of the product of the present application, additions of auxiliary components, and selection of specific methods, etc. all fall within the scope of protection and disclosure of the present application.

What is claimed is:

1. A negative electrode binder, wherein raw materials for preparing the negative electrode binder comprise a soft monomer, a hard monomer, a urethane bond-containing acrylate monomer, an emulsifier, an initiator and water;
the urethane bond-containing acrylate monomer is prepared by reacting a small molecule diol monomethyl ether with a diisocyanate, and followed by end-capping with an acrylate containing a terminal hydroxyl group.

2. The negative electrode binder according to claim 1, wherein the soft monomer comprises any one or a combination of at least two of alkyl acrylate, ethoxy acrylate, methoxy polyethylene glycol methacrylate, methoxy diethylene glycol methacrylate, alkyl methacrylate, or methoxyethyl acrylate;
the hard monomer comprises any one or a combination of at least two of styrene, isobornyl acrylate, isobornyl methacrylate, methyl methacrylate, or diisopropylbenzene.

3. The negative electrode binder according to claim 1, wherein the small molecule diol monomethyl ether comprises any one or a combination of at least two of ethylene glycol monomethyl ether, propylene glycol monomethyl ether, diethylene glycol monomethyl ether, or dipropylene glycol monomethyl ether;
the diisocyanate comprises any one or a combination of at least two of isophorone diisocyanate, dicyclohexylmethane diisocyanate, toluene diisocyanate, and diphenylmethane diisocyanate;
the acrylate containing a terminal hydroxyl group comprises any one or a combination of at least two of hydroxyethyl methacrylate, hydroxyethyl acrylate, hydroxypropyl methacrylate, or hydroxypropyl acrylate;
a molar ratio of the small molecule diol monomethyl ether, the diisocyanate, and the acrylate containing a terminal hydroxyl group is 1:1:1;
the reaction involves adding the diisocyanate dropwise to the small molecule diol monomethyl ether;
the reaction temperature is 10° C. or below;
the reaction time is 1-2 hours;
the end-capping temperature is 70-80° C.;
the end-capping time is 2-3 hours.

4. The negative electrode binder according to claim 2, wherein the small molecule diol monomethyl ether comprises any one or a combination of at least two of ethylene glycol monomethyl ether, propylene glycol monomethyl ether, diethylene glycol monomethyl ether, or dipropylene glycol monomethyl ether;
the diisocyanate comprises any one or a combination of at least two of isophorone diisocyanate, dicyclohexylmethane diisocyanate, toluene diisocyanate, and diphenylmethane diisocyanate;
the acrylate containing a terminal hydroxyl group comprises any one or a combination of at least two of hydroxyethyl methacrylate, hydroxyethyl acrylate, hydroxypropyl methacrylate, or hydroxypropyl acrylate;
a molar ratio of the small molecule diol monomethyl ether, the diisocyanate, and the acrylate containing a terminal hydroxyl group is 1:1:1;
the reaction involves adding the diisocyanate dropwise to the small molecule diol monomethyl ether;
the reaction temperature is 10° C. or below;
the reaction time is 1-2 hours;
the end-capping temperature is 70-80° C.;
the end-capping time is 2-3 hours.

5. The negative electrode binder according to claim 1, wherein the emulsifier comprises an anionic emulsifier and a nonionic emulsifier;
a mass ratio of the anionic emulsifier to the nonionic emulsifier is 1:1-2;
the anionic emulsifier comprises any one or a combination of at least two of sodium dodecyl sulfonate, sodium dodecyl sulfate, or sodium dodecyl benzene sulfonate;
the nonionic emulsifier comprises any one or a combination of at least two of octylphenol polyoxyethylene ether, sorbitan oleate, or fatty alcohol polyoxyethylene ether;
the initiator comprises any one or a combination of at least two of ammonium persulfate, potassium persulfate, azobisisobutyronitrile, or dibenzoyl peroxide.

6. The negative electrode binder according to claim 2, wherein the emulsifier comprises an anionic emulsifier and a nonionic emulsifier;
a mass ratio of the anionic emulsifier to the nonionic emulsifier is 1:1-2;
the anionic emulsifier comprises any one or a combination of at least two of sodium dodecyl sulfonate, sodium dodecyl sulfate, or sodium dodecyl benzene sulfonate;
the nonionic emulsifier comprises any one or a combination of at least two of octylphenol polyoxyethylene ether, sorbitan oleate, or fatty alcohol polyoxyethylene ether;
the initiator comprises any one or a combination of at least two of ammonium persulfate, potassium persulfate, azobisisobutyronitrile, or dibenzoyl peroxide.

7. The negative electrode binder according to claim 3, wherein the emulsifier comprises an anionic emulsifier and a nonionic emulsifier;
a mass ratio of the anionic emulsifier to the nonionic emulsifier is 1:1-2;
the anionic emulsifier comprises any one or a combination of at least two of sodium dodecyl sulfonate, sodium dodecyl sulfate, or sodium dodecyl benzene sulfonate;
the nonionic emulsifier comprises any one or a combination of at least two of octylphenol polyoxyethylene ether, sorbitan oleate, or fatty alcohol polyoxyethylene ether;
the initiator comprises any one or a combination of at least two of ammonium persulfate, potassium persulfate, azobisisobutyronitrile, or dibenzoyl peroxide.

8. The negative electrode binder according to claim 1, wherein the raw materials for preparing the negative electrode binder comprise the following components by mass: 20-35 parts of the soft monomer, 15-30 parts of the hard monomer, 2-5 parts of the urethane bond-containing acrylate monomer, 1.5-3.5 parts of the emulsifier, 0.03-0.1 parts of the initiator, and 35-65 parts of the water.

9. The negative electrode binder according to claim 2, wherein the raw materials for preparing the negative electrode binder comprise the following components by mass: 20-35 parts of the soft monomer, 15-30 parts of the hard monomer, 2-5 parts of the urethane bond-containing acrylate monomer, 1.5-3.5 parts of the emulsifier, 0.03-0.1 parts of the initiator, and 35-65 parts of the water.

10. The negative electrode binder according to claim 3, wherein the raw materials for preparing the negative electrode binder comprise the following components by mass: 20-35 parts of the soft monomer, 15-30 parts of the hard monomer, 2-5 parts of the urethane bond-containing acrylate monomer, 1.5-3.5 parts of the emulsifier, 0.03-0.1 parts of the initiator, and 35-65 parts of the water.

11. The negative electrode binder according to claim 4, wherein the raw materials for preparing the negative electrode binder comprise the following components by mass: 20-35 parts of the soft monomer, 15-30 parts of the hard monomer, 2-5 parts of the urethane bond-containing acrylate monomer, 1.5-3.5 parts of the emulsifier, 0.03-0.1 parts of the initiator, and 35-65 parts of the water.

12. A preparation method for the negative electrode binder according to claim 1, wherein the preparation method comprises the following steps: mixing the soft monomer, the hard monomer, the urethane bond-containing acrylate monomer, the emulsifier, water and the initiator, and reacting to obtain the negative electrode binder.

13. The preparation method for the negative electrode binder according to claim 12, wherein the soft monomer comprises any one or a combination of at least two of alkyl acrylate, ethoxy acrylate, methoxy polyethylene glycol methacrylate, methoxy diethylene glycol methacrylate, alkyl methacrylate, or methoxyethyl acrylate;
the hard monomer comprises any one or a combination of at least two of styrene, isobornyl acrylate, isobornyl methacrylate, methyl methacrylate, or diisopropylbenzene.

14. The preparation method for the negative electrode binder according to claim 12, wherein the mixing comprises the following steps:
(1) mixing part of the emulsifier with part of water to obtain a base solution; mixing the soft monomer, the hard monomer, the acrylate monomer, the remaining emulsifier, and part of water to obtain an emulsion;
(2) mixing the base solution from the step (1), the emulsion from the step (1), and the initiator;
based on 100% of a total mass of the emulsifier, the part of the emulsifier in the preparation of the base solution of the step (1) has a mass percentage of 30-35%;
based on 100% of a total mass of the water, the part of the water in the preparation of the base solution of the step (1) has a mass percentage of 65-70%;
based on 100% of a total mass of the emulsifier, the remaining emulsifier in the preparation of the emulsion of the step (1) has a mass percentage of 65-70%;
based on 100% of a total mass of the water, the part of the water in the preparation of the emulsion of the step (1) has a mass percentage of 30-35%;
the mixing in the step (2) comprises adding the emulsion and the initiator dropwise to the stirred base solution;
the reaction temperature is 83-85° C.;
the reaction time is 1-2 hours.

15. A negative electrode slurry of a battery, comprising the negative electrode binder according to claim 1.

16. A negative electrode sheet, comprising the negative electrode slurry of the battery according to claim 15.

17. An electrochemical energy storage device, comprising the negative electrode slurry of the battery according to claim 15.

18. The electrochemical energy storage device according to claim 17, wherein the electrochemical energy storage device comprises a lithium-ion battery.

19. A negative electrode sheet, comprising the negative electrode binder according to claim 1.

20. An electrochemical energy storage device, comprising the negative electrode binder according to claim 1.
